(19) United States
(12) Patent Application Publication
(10) Pub. No.: US 2018/0128020 A1
(43) Pub. Date: May 10, 2018

(54) ADJUSTABLE BAR WINDOW LOCK

(71) Applicant: Kenneth Smith, South River, NJ (US)

(72) Inventor: Kenneth Smith, South River, NJ (US)

(21) Appl. No.: 15/627,289

(22) Filed: Jun. 19, 2017

Related U.S. Application Data
(60) Provisional application No. 62/351,998, filed on Jun. 19, 2016.

(51) Int. Cl. E05B 65/08; E05B 51/02; E06B 3/44; F24F 1/02

(52) U.S. Cl. CPC E05B 65/0888; E05B 51/02; E05Y 2900/148; F24F 1/027; E06B 3/4415

(57) ABSTRACT

An adjustable bar window lock is a straight bar with a foot at each end, and a snap-locking buckle in the center wherein the two double hung halves of the bar are able to be adjusted incrementally and solidly locked at a preferred length to lock a double hung window in a partially opened position against a window cooling unit to prevent removal or access to the interior of the home.

### CROSS-REFERENCE TO RELATED APPLICATION

The present application is related to and claims priority from prior provisional application Ser. No. 62/351,998, filed Jun. 19, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of window locks and more specifically relates to an adjustable bar window lock.

### 2. DESCRIPTION OF THE RELATED ART

There are many different types of cooling systems that are usually vented through ducting systems built within modern homes. Most generally, these cooling systems are categorized as either Freon air conditioning systems or evaporative water cooling systems. These systems can either be roof mount or ground mount units, and can be further divided into side draft or down draft systems. The cost of cooling systems are relatively pricey, especially when having to replace an air conditioning system as large as a 5 ton unit, which are generally designed for cooling an entire house sized at around 1800 square feet or larger. The purchase and installation will most likely be in the 5,000 and up range. Sometimes, costs can be cut by cooling only the rooms that are occupied most of the time, which can allow the use of much smaller units, such as window air conditioning or window evaporative cooler systems to the preferred rooms. By comparison, these units can be purchased for a few hundred dollars and consume much less electricity than the larger units. Consequently, these units outsell the large units by about 20 to 1. The advantages in cost gained may be lost in the reduced security that is inherent with these units. For instance, the design calls for a window to be opened, the air conditioner or cooler installed in the window, and then the window closed against the cooling unit. As such, it is an easy matter to slide the window open to gain enough space to enter the home without breaking glass or doors. This makes them an easy target for burglars. Most widow locks that hold a window in a partially open position, whether vertical slide or horizontal slide windows, do not lock the window solidly enough that it can't be forced open. In addition, window locks for horizontal double hung windows generally are not ideal for vertical double hung windows and visa versa. A positively working window lock that is ideal for both horizontal slide and vertical slide windows is needed.

Various attempts have been made to solve the above-mentioned problems such as those found in U.S. Pat. No. 3,420,001 to Raymond T Ramon; U.S. Pat. No. 4,461,502 to Rollie M. Burgess; and U.S. Pat. No. 4,368,906 to Wade L. Briggs. This art is representative of adjustable bar window locks for horizontally or vertically opening windows. None of the above inventions and patents, taken either singly or in combination, is seen to describe the invention as claimed.

Ideally, a window lock should provide a positively working window lock that is ideal for both horizontal slide and vertical slide windows, and yet, would operate reliably and be manufactured at a modest expense. Thus, a need exists for a reliable adjustable bar window lock to avoid the above-mentioned problems.

### BRIEF SUMMARY OF THE INVENTION

In view of the foregoing disadvantages inherent in the known window lock art, the present invention provides a novel adjustable bar window lock. The general purpose of the present invention, which will be described subsequently in greater detail, is to provide a positively working window lock that is ideal for both horizontal slide and vertical slide windows.

The adjustable bar window lock for use within double hung window systems may comprise an elongated main body including a first elongated portion forming a hollow interior space therein, a second elongated portion including a series of spaced notches along its length with the second elongated portion telescopically and slidably located within the hollow interior space of the first elongated portion, a first end located on a distal end of the first elongated portion that is adapted to make contact with a portion of a window frame of a double hung window system, a second end located on a distal end of the second elongated portion that is adapted to make contact with a portion of a sash of the double hung window system, and a locking member that is connected to the first elongated portion of the elongated main body that is adapted to releasably engage a chosen one of the series of spaced notches of the second elongated portion such that a predetermined length of the elongated main body can be achieved and held in place via the locking member.

The adjustable bar window lock is adapted to make contact with the window frame of a double hung window system and the sash of the double hung window system in order to hold respective double hung window panes of the double hung window system in a chosen position. The locking member may comprise a left side locking portion having a V-shape and the apex of the V-shape is pivotally connected to a left side of the first elongated portion of the elongated main body and a right side locking portion with the right side locking portion also having a V-shape with the apex of the V-shape pivotally connected to a right side of the first elongated portion of the elongated main body. A first cross member is connected between the first end of the left side locking portion and the first end of the right side locking portion and is adapted to abut to a side of the first elongated portion of the elongated main body in between the left side and the right side.

A second cross member is connected between the second end of the left side locking portion and the second end of the right side locking portion and is adapted to abut to a side of the second elongated portion of the elongated main body where the series of spaced notches are located. The second cross member is adapted to be selectively placed and held within a chosen one of the series of spaced notches such that a predetermined length of the elongated main body can be achieved and held in place via the locking member.

A resilient member is connected to the first cross member and is adapted to contact the first elongated portion of the elongated main body and bias the first cross member away from the first elongated portion to thereby force the second cross member toward the second elongated portion and into the chosen one of the series of spaced notches. The resilient member preferably includes a spring member. The first end and the second end are formed from a material chosen from the group of materials consisting of plastic and rubber.

A pneumatic tube may be located within the hollow interior space of the first elongated portion and connected between the first elongated portion and the second elongated portion and adapted to push the first and second elongated portions away from one another to thereby lengthen the adjustable bar window lock.

An improved double hung window system for use with removable air conditioning units may comprise a window frame including a plurality of side portions, at least two slide window members each including a sash, and at least one window attached to the sash. The slide window members are slidably connected to two opposite side portions of the window frame. The adjustable bar window lock comprises an elongated main body including a first elongated portion that forms a hollow interior space therein, a second elongated portion including a series of spaced notches along its length and is telescopically and slidably located within the hollow interior space of the first elongated portion. The first end is located on a distal end of the first elongated portion and is adapted to make contact with the side portion of the window frame of the improved double hung window system. The second end is located on a distal end of the second elongated portion and is adapted to make contact with a sash of one of the slide window members of the double hung window system.

The locking member is connected to the first elongated portion of the elongated main body and is adapted to releasably engage a chosen one of the series of spaced notches of the second elongated portion, such that a predetermined length of the elongated main body can be achieved and held in place via the locking member. The adjustable bar window lock is adapted to make contact with the window frame of the improved double hung window system and the sash of the slide window members in a chosen position.

The locking member comprises a left side locking portion having a V-shape with the apex of the V-shape pivotally connected to the left side of the first elongated portion of the elongated main body. The right side locking portion has a V-shape and the apex of the V-shape is pivotally connected to a right side of the first elongated portion of the elongated main body. The first cross member is connected between a first end of the left side locking portion and the first end of the right side locking portion and is adapted to abut a side of the first elongated portion of the elongated main body in between the left side and the right side. The second cross member is connected between the second end of the left side locking portion and the second end of the right side locking portion and is adapted to abut a side of the second elongated portion of the elongated main body where the series of spaced notches are located. The second cross member is adapted to be selectively placed and held within a chosen one of the series of spaced notches such that a predetermined length of the elongated main body can be achieved and held in place via the locking member.

The resilient member is connected to the first cross member and is adapted to contact the first elongated portion of the elongated main body and bias the first cross member away from the first elongated portion to thereby force the second cross member toward the second elongated portion and into a chosen one of the series of spaced notches. The resilient member includes a spring member. The first end and the second end are formed from a material chosen from a group of materials consisting of plastic and rubber. A pneumatic tube may be located within the hollow interior space of the first elongated portion connected between the first elongated portion and the second elongated portion, and adapted to push the first and second elongated portions away from one another to thereby lengthen the adjustable bar window lock.

The combination of a removable air conditioning unit and an improved double hung window system may comprise a removable air conditioning unit having a main body with a rectangular cross-section and adapted to be removably fit within window frames, and an improved double hung window system for use with the removable air conditioning unit, comprising a window frame including a plurality of side portions, at least two slide window members each including a sash, and at least one window attached to the sash. The slide window members are slidably connected to two opposite side portions of the window frame. The adjustable bar window lock may comprise an elongated main body having a first elongated portion forming a hollow interior space within, and a second elongated portion including a series of spaced notches along its length. The second elongated portion is telescopically and slidably located within the hollow interior space of the first elongated portion. The first end is located on the distal end of the first elongated portion and is adapted to make contact with the side portion of the window frame of the improved double hung window system. The second end is located on the distal end of the second elongated portion and is adapted to make contact with the sash of one of the slide window members of the double hung window system.

The locking member is connected to the first elongated portion of the elongated main body and is adapted to releasably engage a chosen one of the series of spaced notches of the second elongated portion, such that a predetermined length of the elongated main body can be achieved and held in place via the locking member. The adjustable bar window lock is adapted to make contact with the window frame of the improved double hung window system and the sash of the slide window members of in a chosen position, and the removable air conditioning unit is adapted to be removably fit within the window frame.

The sash of the slide window members are moved to a position contacting and holding the removable air conditioning unit in position within the window frame, and the adjustable bar window lock placed between the window frame and the sash to hold the sash and the removable air conditioning unit in position. The locking member comprises a left side locking portion having a V-shape and the apex of the V-shape is pivotally connected to a left side of the first elongated portion of the elongated main body. The right side locking portion has a V-shape and the apex of the V-shape is pivotally connected to the right side of the first elongated portion of the elongated main body. The first cross member is connected between the first end of the left side locking portion and the first end of the right side locking portion and is adapted to abut the side of the first elongated portion of the elongated main body in between the left side and the right side. The second cross member is connected between the second end of the left side locking portion and the second end of the right side locking portion and is adapted to abut a side of the second elongated portion of the elongated main body where the series of spaced notches are located. The second cross member is adapted to be selectively placed and held within a chosen one of the series of spaced notches, such that a predetermined length of the elongated main body can be achieved and held in place via the locking member.

The resilient member is connected to the first cross member and is adapted to contact the first elongated portion of the elongated main body and bias the first cross member away from the first elongated portion, to thereby force the second cross member toward the second elongated portion and into the chosen one of the series of spaced notches. The resilient member includes a spring member. The first end and the second end are formed from a material chosen from a group of materials consisting of plastic and rubber. A pneumatic tube may be located within the hollow interior space of the first elongated portion and connected between the first elongated portion and the second elongated portion, and adapted to push the first and second elongated portions away from one another to thereby lengthen the adjustable bar window lock.

The present invention holds significant improvements and serves as an adjustable bar window lock. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, adjustable bar window lock, constructed and operative according to the teachings of the present invention.

FIG. 1 shows a perspective view illustrating an adjustable bar window lock according to an embodiment of the present invention.

FIG. 2 is a perspective view illustrating an improved double hung window system according to an embodiment of the present invention of FIG. 1.

FIG. 3 is a perspective view illustrating an combination of a removable air conditioning unit and an improved double hung window system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a window lock and more particularly to a an adjustable bar window lock as used to improve the positive locking of windows that is ideal for both horizontal slide and vertical slide windows.

Generally speaking, an adjustable bar window lock is a straight bar with a foot at each end, and a snap-locking buckle in the center wherein the two double hung halves of the bar are able to be adjusted incrementally and solidly locked at a preferred length to lock a double hung window in a partially opened position against a window cooling unit to prevent removal or access to the interior of the home.

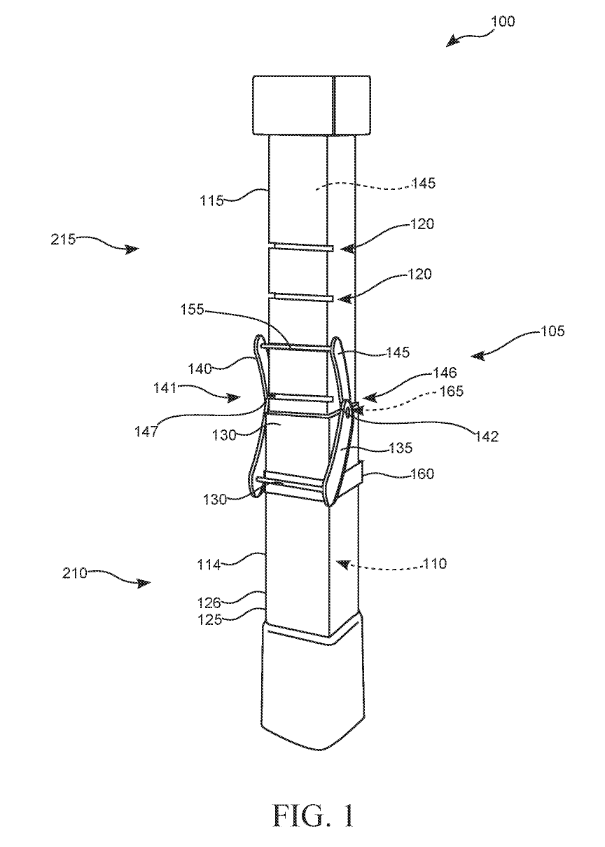

In greater detail now, referring to the drawings by numerals of reference there is shown in FIG. 1, a perspective view illustrating an adjustable bar window lock 100 according to an embodiment of the present invention.

Adjustable bar window lock 100 for use within double hung window systems 190 may comprise elongated main body 105 including first elongated portion 114 forming hollow interior space 110 therein, second elongated portion 115 including series of spaced notches 120 along its length with second elongated portion 115 telescopically and slidably located within hollow interior space 110 of first elongated portion 114, first end 125 located on distal end 126 of first elongated portion 114 that is adapted to make contact with a portion of window frame 180 of double hung window systems 190, second end 130 located on distal end 126 of second elongated portion 115 that is adapted to make contact with a portion of sash 183 of double hung window systems 190, and locking member 135 that is connected to first elongated portion 114 of elongated main body 105 that is adapted to releasably engage a chosen one of series of spaced notches 120 of second elongated portion 115 such that a predetermined length of elongated main body 105 can be achieved and held in place via locking member 135.

Adjustable bar window lock 100 is adapted to make contact with window frame 180 of double hung window systems 190 and sash 183 of double hung window systems 190 in order to hold respective slide window members 182 of double hung window systems 190 in a chosen position. Locking member 135 may comprise left side locking portion 140 having v-shape 141 and apex 142 of v-shape 141 is pivotally connected to a left side of first elongated portion 114 of elongated main body 105 and right side locking portion 145 with right side locking portion 145 also having v-shape 146 with apex 147 of v-shape 146 pivotally connected to a right side of first elongated portion 114 of elongated main body 105. First cross member 150 is connected between first end 125 of left side locking portion 140 and first end 125 of right side locking portion 145 and is adapted to abut to a side of first elongated portion 114 of elongated main body 105 in between the left side and the right side.

Second cross member 155 is connected between second end 130 of left side locking portion 140 and second end 130 of right side locking portion 145 and is adapted to abut to a side of second elongated portion 115 of elongated main body 105 where series of spaced notches 120 are located. Second cross member 155 is adapted to be selectively placed and held within a chosen one of series of spaced notches 120 such that a predetermined length of elongated main body 105 can be achieved and held in place via locking member 135.

Resilient member 160 is connected to first cross member 150 and is adapted to contact first elongated portion 114 of elongated main body 105 and bias first cross member 150 away from first elongated portion 114 to thereby force second cross member 155 toward second elongated portion 115 and into the chosen one of series of spaced notches 120. Resilient member 160 preferably includes spring member 165. First end 125 and second end 130 are formed from a material chosen from the group of materials consisting of plastic and rubber.

Pneumatic tube 170 may be located within hollow interior space 110 of first elongated portion 114 and connected between first elongated portion 114 and second elongated portion 115 and adapted to push first elongated portion 114 and second elongated portion 115 away from one another to thereby lengthen adjustable bar window lock 100.

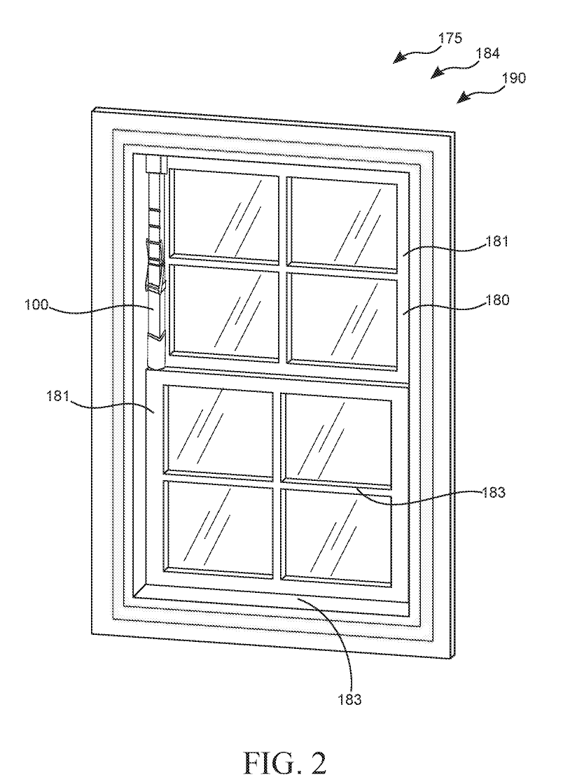

Referring now to FIG. 2, is a perspective view illustrating improved double hung window system 175 according to an embodiment of the present invention of FIG. 1.

Improved double hung window system 175 for use with removable air conditioning units 205 may comprise window frame 180 including plurality of side portions 181, at least two slide window members 182 each including sash 183, and at least one slide window member 182 attached to sash 183. Slide window members 182 are slidably connected to two opposite side portions of window frame 180. Adjustable bar window lock 100 comprises elongated main body 105 including first elongated portion 114 that forms hollow interior space 110 therein, second elongated portion 115 including series of spaced notches 120 along its length and is telescopically and slidably located within hollow interior space 110 of first elongated portion 114. First end 125 is located on distal end 126 of first elongated portion 114 and is adapted to make contact with the side portion of window frame 180 of improved double hung window system 175. Second end 130 is located on distal end 126 of second elongated portion 115 and is adapted to make contact with sash 183 of one of slide window members 182 of double hung window systems 190.

Locking member 135 is connected to first elongated portion 114 of elongated main body 105 and is adapted to releasably engage a chosen one of series of spaced notches 120 of second elongated portion 115, such that a predetermined length of elongated main body 105 can be achieved and held in place via locking member 135. Adjustable bar window lock 100 is adapted to make contact with window frame 180 of improved double hung window system 175 and sash 183 of slide window members 182 in a chosen position.

Locking member 135 comprises left side locking portion 140 having V-shape 141 with apex 142 of V-shape 141 pivotally connected to the left side of first elongated portion 114 of elongated main body 105. Right side locking portion 145 has V-shape 146 and apex 147 of V-shape 146 is pivotally connected to a right side of first elongated portion 114 of elongated main body 105. First cross member 150 is connected between first end 125 of left side locking portion 140 and first end 125 of right side locking portion 145 and is adapted to abut a side of first elongated portion 114 of elongated main body 105 in between the left side and the right side. Second cross member 155 is connected between second end 130 of left side locking portion 140 and second end 130 of right side locking portion 145 and is adapted to abut a side of second elongated portion 115 of elongated main body 105 where series of spaced notches 120 are located. Second cross member 155 is adapted to be selectively placed and held within a chosen one of series of spaced notches 120 such that a predetermined length of elongated main body 105 can be achieved and held in place via locking member 135.

Resilient member 160 is connected to first cross member 150 and is adapted to contact first elongated portion 114 of elongated main body 105 and bias t first cross member 150 from first elongated portion 114 to thereby force second cross member 155 toward second elongated portion 115 and into a chosen one of series of spaced notches 120. Resilient member 160 includes spring member 165. First end 125 and second end 130 are formed from a material chosen from a group of materials consisting of plastic and rubber. Pneumatic tube 170 may be located within hollow interior space 110 of first elongated portion 114 connected between first elongated portion 114 and second elongated portion 115, and adapted to push first 114 and second elongated portions 115 away from one another to thereby lengthen adjustable bar window lock 100.

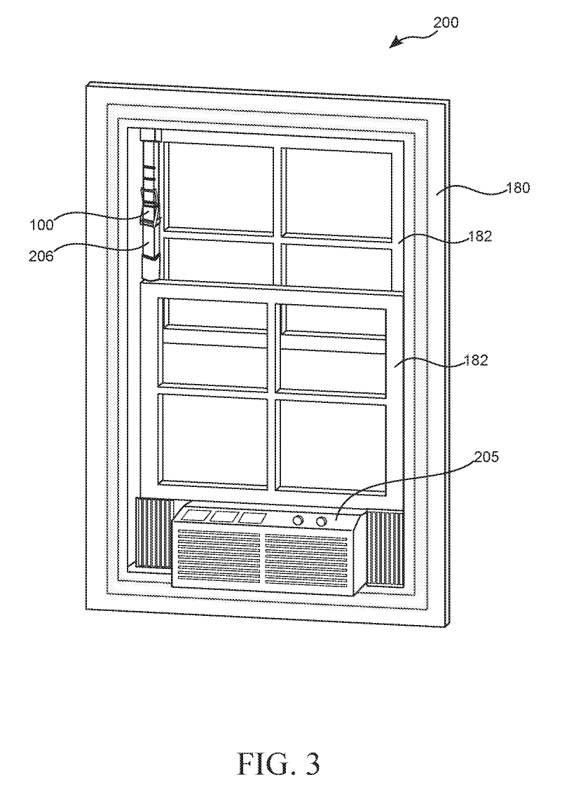

Referring now to FIG. 3, is a perspective view illustrating combination of a removable air conditioning unit and an improved double hung window system 200 according to an embodiment of the present invention of FIG. 1.

Combination of a removable air conditioning unit and an improved double hung window system 200 may comprise removable air conditioning unit 205 having main body 206 with a rectangular cross-section and adapted to be removably fit within window frame 180, and improved double hung window system 175 for use with removable air conditioning unit 205, comprising window frame 180 including plurality of side portions 181, at least two slide window members 182 each including sash 183, and at least window frame 180 attached to sash 183. Slide window members 182 are slidably connected to two opposite side portions of window frame 180. Adjustable bar window lock 100 may comprise elongated main body 105 having first elongated portion 114 forming hollow interior space 110 within, and second elongated portion 115 including series of spaced notches 120 along its length. Second elongated portion 115 is telescopically and slidably located within hollow interior space 110 of first elongated portion 114. First end 125 is located on distal end 126 of first elongated portion 114 and is adapted to make contact with the side portion of window frame 180 of improved double hung window system 175. Second end 130 is located on distal end 126 of second elongated portion 115 and is adapted to make contact with sash 183 of one of slide window members 182 of double hung window systems 190.

Locking member 135 is connected to first elongated portion 114 of elongated main body 105 and is adapted to releasably engage a chosen one of series of spaced notches 120 of second elongated portion 115, such that a predetermined length of elongated main body 105 can be achieved and held in place via locking member 135. Adjustable bar window lock 100 is adapted to make contact with window frame 180 of improved double hung window system 175 and sash 183 of slide window members 182 of in a chosen position, and removable air conditioning unit 205 is adapted to be removably fit within window frame 180.

Sash 183 of slide window members 182 are moved to a position contacting and holding removable air conditioning unit 205 in position within window frame 180, and adjustable bar window lock 100 placed between window frame 180 and sash 183 to hold sash 183 and removable air conditioning unit 205 in position. Locking member 135 comprises left side locking portion 140 having v-shape 141 and apex 142 of v-shape 141 is pivotally connected to a left side of first elongated portion 114 of elongated main body 105. Right side locking portion 145 has v-shape 146 and apex 147 of v-shape 146 is pivotally connected to the right side of first elongated portion 114 of elongated main body 105. First cross member 150 is connected between first end 125 of left side locking portion 140 and first end 125 of right side locking portion 145 and is adapted to abut the side of first elongated portion 114 of elongated main body 105 in between the left side and the right side. Second cross member 155 is connected between second end 130 of left side locking portion 140 and second end 130 of right side locking portion 145 and is adapted to abut a side of second elongated portion 115 of elongated main body 105 where series of spaced notches 120 are located. Second cross member 155 is adapted to be selectively placed and held within a chosen one of series of spaced notches 120, such that a predetermined length of elongated main body 105 can be achieved and held in place via locking member 135.

resilient member 160 is connected to first cross member 150 and is adapted to contact first elongated portion 114 of elongated main body 105 and bias first cross member 150 away from first elongated portion 114, to thereby force second cross member 155 toward second elongated portion 115 and into the chosen one of series of spaced notches 120. Resilient member 160 includes spring member 165. First end 125 and second end 130 are formed from a material chosen from a group of materials consisting of plastic and rubber. Pneumatic tube 170 may be located within hollow interior space 110 of first elongated portion 114 and connected between first elongated portion 114 and second elongated portion 115, and adapted to push the first 114 and second elongated portions 115 away from one another to thereby lengthen adjustable bar window lock 100.

Adjustable bar window lock 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the u.s. patent and trademark office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An adjustable bar window lock for use within double hung window systems, comprising:
an elongated main body including;
a first elongated portion;
wherein said first elongated portion forms a hollow interior space therein;
a second elongated portion including;
a series of spaced notches along its length thereof;
wherein said second elongated portion is telescopically and slidably located within said hollow interior space of said first elongated portion;
a first end;
wherein said first end is located on a distal end of said first elongated portion and is adapted to make contact with a portion of a window frame of a double hung window system;
a second end;
wherein said second end is located on a distal end of said second elongated portion and is adapted to make contact with a portion of a sash of said double hung window system; and
a locking member;
wherein said locking member is connected to said first elongated portion of said elongated main body and is adapted to releasably engage a chosen one of said series of spaced notches of said second elongated portion, such that a predetermined length of said elongated main body can be achieved and held in place via said locking member;
wherein said adjustable bar window lock is adapted to make contact with said window frame of a double hung window system and said sash of said double hung window system in order to hold respective double hung window panes of said double hung window system in a chosen position.

2. The adjustable bar window lock of claim 1, wherein said locking member comprises:
a left side locking portion;
wherein said left side locking portion has a V-shape wherein an apex of said V-shape is pivotally connected to a left side of said first elongated portion of said elongated main body;
a right side locking portion;
wherein said right side locking portion has a V-shape wherein an apex of said V-shape is pivotally connected to a right side of said first elongated portion of said elongated main body;
a first cross member;
wherein said first cross member is connected between a first end of said left side locking portion and a first end of said right side locking portion and is adapted to abut a side of said first elongated portion of said elongated main body in between said left side and said right side; and
a second cross member;
wherein said second cross member is connected between a second end of said left side locking portion and a second end of said right side locking portion and is adapted to abut a side of said second elongated portion of said elongated main body where said series of spaced notches are located; and
wherein said second cross member is adapted to be selectively placed and held within a chosen one of said series of spaced notches, such that a predetermined length of said elongated main body can be achieved and held in place via said locking member; and
a resilient member;
wherein said resilient member is connected to said first cross member and is adapted to contact to said first elongated portion of said elongated main body and bias said first cross member away from said first elongated portion, to thereby force said second cross member toward said second elongated portion and into said chosen one of said series of spaced notches.

3. The adjustable bar window lock of claim 2, wherein said resilient member includes a spring member.

4. The adjustable bar window lock of claim 1, wherein said first end and said second end are formed from a material chosen from a group of materials consisting of plastic and rubber.

5. The adjustable bar window lock of claim 1, further comprising a pneumatic tube located within said hollow interior space of said first elongated portion and connected between said first elongated portion and said second elongated portion, and adapted to push said first and second elongated portions away from one another to thereby lengthen the adjustable bar window lock.

6. An improved double hung window system for use with removable air conditioning units, comprising:
a window frame including;
a plurality of side portions;
at least two slide window members, each including;
a sash; and
at least one window attached to said sash;
wherein said at least two slide window members are slidably connected to two opposite side portions of said window frame; and
an adjustable bar window lock, comprising:
an elongated main body including;
a first elongated portion;
wherein said first elongated portion forms a hollow interior space therein;
a second elongated portion including;
a series of spaced notches along its length thereof;
wherein said second elongated portion is telescopically and slidably located within said hollow interior space of said first elongated portion;
a first end;
wherein said first end is located on a distal end of said first elongated portion and is adapted to make contact with a side portion of said window frame of said improved double hung window system;
a second end;
wherein said second end is located on a distal end of said second elongated portion and is adapted to make contact with a sash of one of said at least two slide window members of said double hung window system; and
a locking member;
wherein said locking member is connected to said first elongated portion of said elongated main body and is adapted to releasably engage a chosen one of said series of spaced notches of said second elongated portion, such that a predetermined length of said elongated main body can be achieved and held in place via said locking member;
wherein said adjustable bar window lock is adapted to make contact with said window frame of said improved double hung window system and said sash of said at least two slide window members of in a chosen position.

7. The adjustable bar window lock of claim 6, wherein said locking member comprises:
a left side locking portion;
wherein said left side locking portion has a V-shape wherein an apex of said V-shape is pivotally connected to a left side of said first elongated portion of said elongated main body;
a right side locking portion;
wherein said right side locking portion has a V-shape wherein an apex of said V-shape is pivotally connected to a right side of said first elongated portion of said elongated main body;
a first cross member;
wherein said first cross member is connected between a first end of said left side locking portion and a first end of said right side locking portion and is adapted to abut a side of said first elongated portion of said elongated main body in between said left side and said right side; and
a second cross member;
wherein said second cross member is connected between a second end of said left side locking portion and a second end of said right side locking portion and is adapted to abut a side of said second elongated portion of said elongated main body where said series of spaced notches are located; and
wherein said second cross member is adapted to be selectively placed and held within a chosen one of said series of spaced notches, such that a predetermined length of said elongated main body can be achieved and held in place via said locking member; and
a resilient member;
wherein said resilient member is connected to said first cross member and is adapted to contact to said first elongated portion of said elongated main body and bias said first cross member away from said first elongated portion, to thereby force said second cross member toward said second elongated portion and into said chosen one of said series of spaced notches.

8. The adjustable bar window lock of claim 7, wherein said resilient member includes a spring member.

9. The adjustable bar window lock of claim 6, wherein said first end and said second end are formed from a material chosen from a group of materials consisting of plastic and rubber.

10. The adjustable bar window lock of claim 6, further comprising a pneumatic tube located within said hollow interior space of said first elongated portion and connected between said first elongated portion and said second elongated portion, and adapted to push said first and second elongated portions away from one another to thereby lengthen the adjustable bar window lock.

11. A combination of a removable air conditioning unit and an improved double hung window system, said combination comprising:
a removable air conditioning unit including;
a main body having a rectangular cross-section and adapted to be removably fit within window frames; and
an improved double hung window system for use with said removable air conditioning unit, comprising:
a window frame including;
a plurality of side portions;
at least two slide window members, each including;
a sash; and
at least one window attached to said sash;
wherein said at least two slide window members are slidably connected to two opposite side portions of said window frame; and
an adjustable bar window lock, comprising:
an elongated main body including;
a first elongated portion;
wherein said first elongated portion forms a hollow interior space therein;
a second elongated portion including;
a series of spaced notches along its length thereof;
wherein said second elongated portion is telescopically and slidably located within said hollow interior space of said first elongated portion;
a first end;
wherein said first end is located on a distal end of said first elongated portion and is adapted to make contact with a side portion of said window frame of said improved double hung window system;
a second end;
wherein said second end is located on a distal end of said second elongated portion and is adapted to make contact with a sash of one of said at least two slide window members of said double hung window system;
and
a locking member;
wherein said locking member is connected to said first elongated portion of said elongated main body and is adapted to releasably engage a chosen one of said series of spaced notches of said second elongated portion, such that a predetermined length of said elongated main body can be achieved and held in place via said locking member;
wherein said adjustable bar window lock is adapted to make contact with said window frame of said improved double hung window system and said sash of said at least two slide window members of in a chosen position; and
wherein said removable air conditioning unit is adapted to be removably fit within said window frame, said sash of said at least two slide window members moved to a position contacting and holding said removable air conditioning unit in position within said window frame, and said adjustable bar window lock placed between said window frame and said sash to hold said sash and said removable air conditioning unit in position.

12. The adjustable bar window lock of claim 11, wherein said locking member comprises:
a left side locking portion;
wherein said left side locking portion has a V-shape wherein an apex of said V-shape is pivotally connected to a left side of said first elongated portion of said elongated main body;
a right side locking portion;
wherein said right side locking portion has a V-shape wherein an apex of said V-shape is pivotally connected to a right side of said first elongated portion of said elongated main body;
a first cross member;
wherein said first cross member is connected between a first end of said left side locking portion and a first end of said right side locking portion and is adapted to abut a side of said first elongated portion of said elongated main body in between said left side and said right side; and
a second cross member;
wherein said second cross member is connected between a second end of said left side locking portion and a second end of said right side locking portion and is adapted to abut a side of said second elongated portion of said elongated main body where said series of spaced notches are located; and
wherein said second cross member is adapted to be selectively placed and held within a chosen one of said series of spaced notches, such that a predetermined length of said elongated main body can be achieved and held in place via said locking member; and
a resilient member;
wherein said resilient member is connected to said first cross member and is adapted to contact to said first elongated portion of said elongated main body and bias said first cross member away from said first elongated portion, to thereby force said second cross member toward said second elongated portion and into said chosen one of said series of spaced notches.

13. The adjustable bar window lock of claim 12, wherein said resilient member includes a spring member.

14. The adjustable bar window lock of claim 11, wherein said first end and said second end are formed from a material chosen from a group of materials consisting of plastic and rubber.

15. The adjustable bar window lock of claim 11, further comprising a pneumatic tube located within said hollow interior space of said first elongated portion and connected between said first elongated portion and said second elongated portion, and adapted to push said first and second elongated portions away from one another to thereby lengthen the adjustable bar window lock.
